(19) United States
(12) Patent Application Publication
(10) Pub. No.: US 2026/0081385 A1
(43) Pub. Date: Mar. 19, 2026

(54) UNLOCKING ELASTIC PIECE WITH SUPPORT ARM AND ELECTRICAL CONNECTOR

(71) Applicant: DONGGUAN LUXSHARE TECHNOLOGIES CO., LTD, Dongguan City (CN)

(72) Inventors: Xuzong HUANG, Dongguan City (CN); Sihai YI, Dongguan City (CN); Zhaolong ZENG, Dongguan City (CN); Kaide WANG, Dongguan City (CN)

(73) Assignee: DONGGUAN LUXSHARE TECHNOLOGIES CO., LTD, Dongguan City (CN)

(21) Appl. No.: 18/931,906

(22) Filed: Oct. 30, 2024

(30) Foreign Application Priority Data
Sep. 14, 2024 (CN) 202422266235.7

(51) Int. Cl. H01R 13/627; H01R 13/66

(52) U.S. Cl. CPC H01R 13/6275; H01R 13/6658

(57) ABSTRACT

An unlocking elastic piece includes a fixing portion, a locking portion, a connecting portion, a connecting arm, a support arm and a force-receiving portion. The locking portion is provided with at least one locking element. The connecting portion connects one end of the fixing portion and one end of the locking portion. The connecting arm is connected to the locking portion. The support arm is located beside the connecting arm. The support arm and the connecting arm are disposed staggered along a first direction. The connecting arm and the support arm are connected between the locking portion and the force-receiving portion. The force-receiving portion is configured to drive the locking portion to deform under an action of an external force, thereby causing the locking element to separate from a mating connector. An electrical connector having the unlocking elastic piece is also disclosed.

### CROSS-REFERENCE TO RELATED APPLICATION

This patent application claims priority of a Chinese Patent Application No. 202422266235.7, filed on Sep. 14, 2024 and titled “UNLOCKING ELASTIC PIECE AND ELECTRICAL CONNECTOR”, the entire content of which is incorporated herein by reference.

### TECHNICAL FIELD

The present disclosure relates to an unlocking elastic piece and an electrical connector, which belongs to the technical field of connectors.

### BACKGROUND

A connector assembly in the related art typically includes an electrical connector (e.g., a plug connector) and a mating connector (e.g., a receptacle connector). The electrical connector generally includes an unlocking elastic piece. The unlocking elastic piece is provided with at least one locking element (for example, a locking protrusion). The mating connector is provided with a locking hole that mates with the locking protrusion.

When it is necessary to unlock the electrical connector and the mating connector, an external force acting directly or indirectly on the unlocking elastic piece presses the unlocking elastic piece, causing the locking protrusion to separate from the locking hole.

However, after being pressed multiple times, the elastic deformation ability of the unlocking elastic piece decreases, and locking/unlocking failure may easily occur due to insufficient deformation of the unlocking elastic piece.

Therefore, it is desirable to improve the unlocking elastic piece in related technologies.

### SUMMARY

An object of the present disclosure is to provide a reliable unlocking elastic piece and an electrical connector having the unlocking elastic piece.

In order to achieve the above object, the present disclosure adopts the following technical solution: an unlocking elastic piece, including: a fixing portion, the fixing portion being configured to be mounted to a first body of an electrical connector; a locking portion, the locking portion being provided with at least one locking element which is lockable with a mating connector; a connecting portion, the connecting portion connecting one end of the fixing portion and one end of the locking portion; a connecting arm, the connecting arm being connected to the locking portion; a support arm, the support arm being connected to the locking portion, the support arm being located beside the connecting arm, the support arm and the connecting arm being disposed in a staggered manner along a first direction; and a force-receiving portion, both the connecting arm and the support arm being connected between the locking portion and the force-receiving portion, the force-receiving portion being configured to drive the locking portion to elastically deform under an action of an external force, thereby causing the locking element to separate from the mating connector.

In order to achieve the above object, the present disclosure adopts the following technical solution: an electrical connector, including: a first body, the first body defining a mounting groove; and an unlocking elastic piece, including: a fixing portion, the fixing portion being fixed in the mounting groove; a locking portion, the locking portion being provided with at least one locking element which is lockable with a mating connector; a connecting portion, the connecting portion connecting one end of the fixing portion and one end of the locking portion; a connecting arm, the connecting arm being connected to the locking portion; a support arm, the support arm being connected to the locking portion, the support arm being located beside the connecting arm, the support arm and the connecting arm being disposed in a staggered manner along a first direction; and a force-receiving portion, both the connecting arm and the support arm being connected between the locking portion and the force-receiving portion, the force-receiving portion being configured to drive the locking portion to elastically deform under an action of an external force, thereby causing the locking element to separate from the mating connector.

Compared with the prior art, the unlocking elastic piece and the electrical connector of the present disclosure are provided with the support arm. The support arm and the connecting arm are arranged staggered along the first direction. When the force-receiving portion receives the external force, the support arm can form a balance lever, thereby improving a defect that a connection between the connecting arm and the force-receiving portion itself is prone to elastic deformation. Finally, the external force exerted on the force-receiving portion can be better transmitted to the locking portion and drive the locking portion to undergo elastic deformation. As a result, it reduces the risk of unlocking failure due to insufficient elastic deformation of the locking portion and improves reliability.

### BRIEF DESCRIPTION OF DRAWINGS

FIG. 1 is a perspective view of a connector assembly in accordance with an embodiment of the present disclosure, in which an electrical connector and a mating connector are in a locked state;

FIG. 2 is a partially exploded perspective view of FIG. 1, in which the electrical connector and the mating connector are separated from each other;

FIG. 3 is a perspective schematic view of the mating connector in FIG. 2;

FIG. 4 is a right side view of the electrical connector shown in FIG. 2;

FIG. 5 is a top view of FIG. 4;

FIG. 6 is a perspective view of the electrical connector in FIG. 2 from another angle;

FIG. 7 is a partially exploded perspective view of FIG. 6, in which an unlocking elastic piece is separated;

FIG. 8 is a partially exploded perspective view of FIG. 7 from another angle;

FIG. 9 is a perspective schematic view of the unlocking elastic piece in FIG. 7;

FIG. 10 is a perspective schematic view of the unlocking elastic piece in FIG. 8;

FIG. 11 is a right view of FIG. 9;

FIG. 12 is a top view of FIG. 9;

FIG. 13 is a perspective view of the connector assembly in accordance with an embodiment of the present disclosure, in which the electrical connector and the mating connector are in an unlocked state;

FIG. 14 is a schematic perspective view of the unlocking elastic piece in FIG. 13 when it is in the unlocked state;

FIG. 15 is a perspective view of FIG. 14 from another angle;

FIG. 16 is a right view of FIG. 15;

FIG. 17 is a perspective view of the unlocking elastic piece in FIG. 9 in accordance with another embodiment of the present disclosure;

FIG. 18 is a perspective view of FIG. 17 from another angle;

FIG. 19 is a right view of FIG. 17; and

FIG. 20 is a top view of FIG. 17.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of”mentioned in the present disclosure includes two or more.

Hereinafter, some embodiments of the present disclosure will be described in detail with reference to the accompanying drawings. In the case of no conflict, the following embodiments and features in the embodiments can be combined with each other.

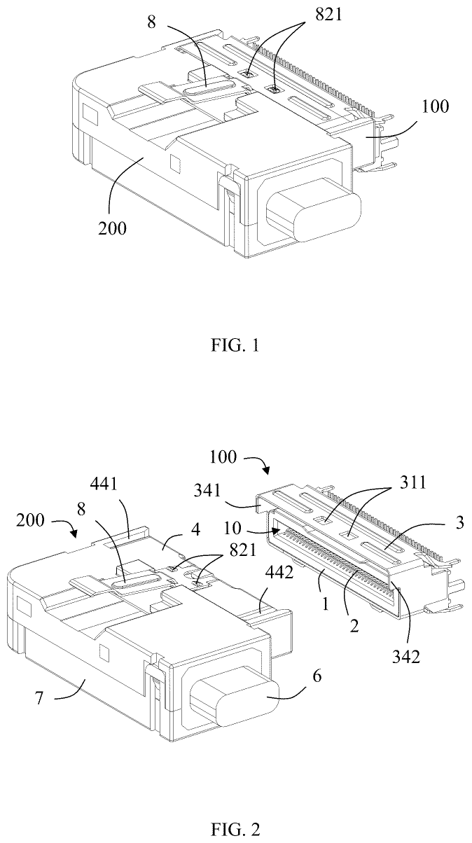

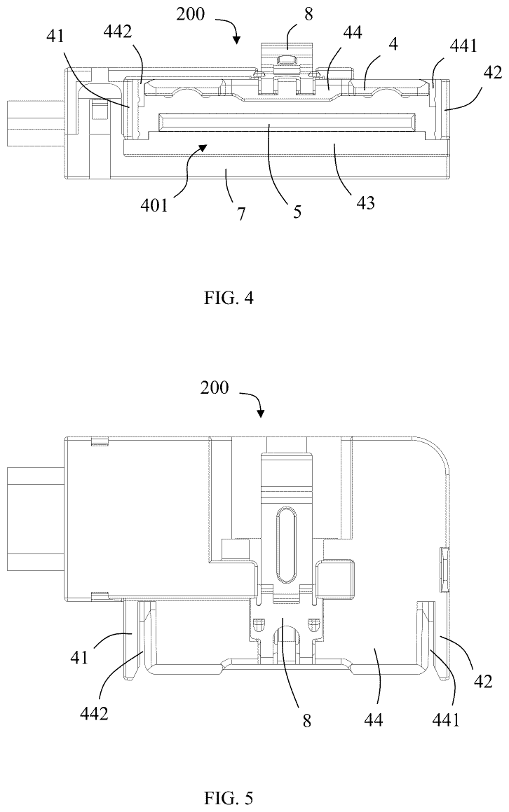

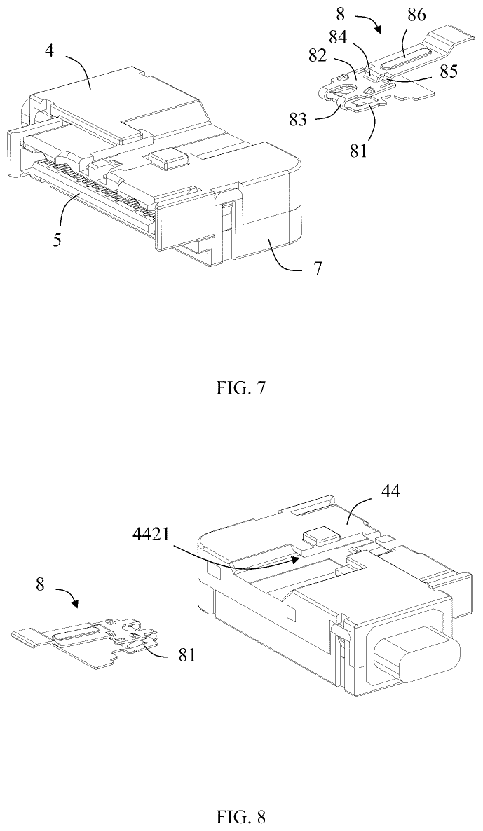

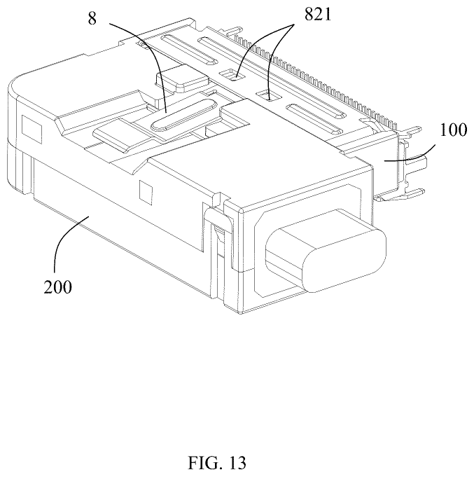

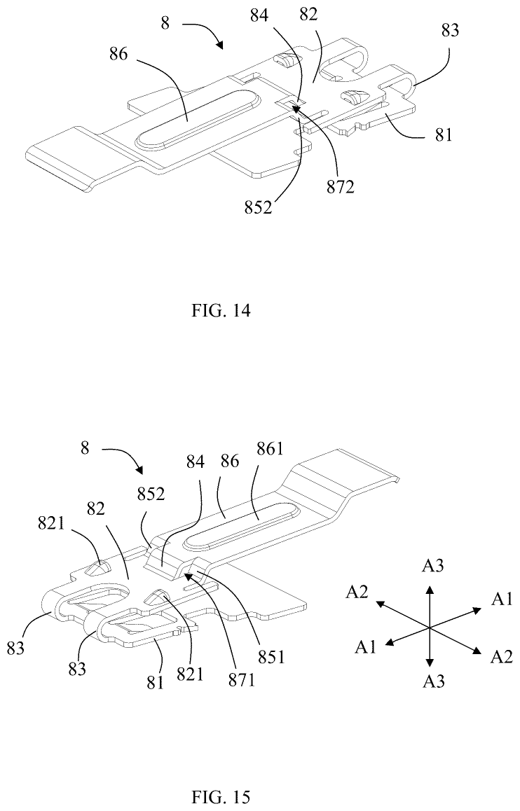

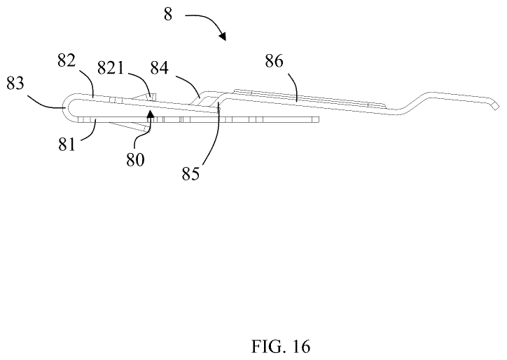

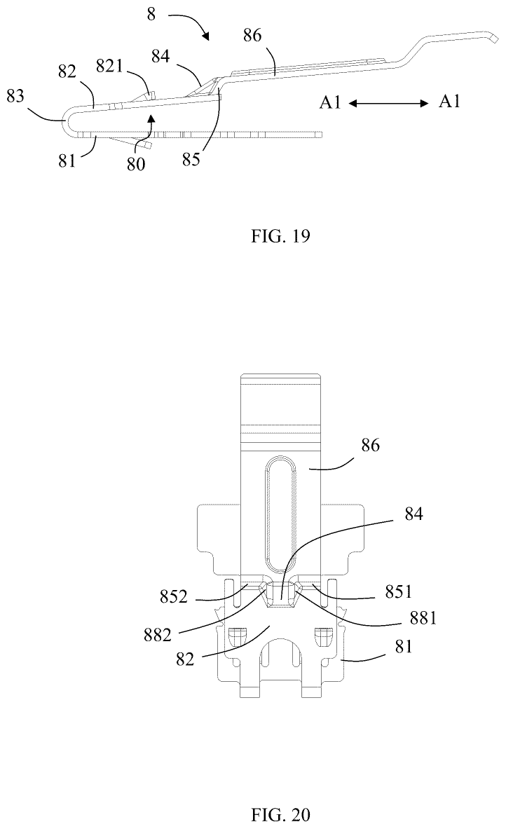

Referring to FIG. 1 to FIG. 20, the present disclosure discloses a connector assembly including a mating connector 100 and an electrical connector 200 matched with the mating connector 100. In an embodiment shown in the present disclosure, the mating connector 100 is an SFP (Small Form-Factor Pluggable) receptacle connector. The electrical connector 200 is an SFP plug connector. Of course, it is understandable to those skilled in the art that the mating connector 100 and the electrical connector 200 may also be other types of electrical connectors.

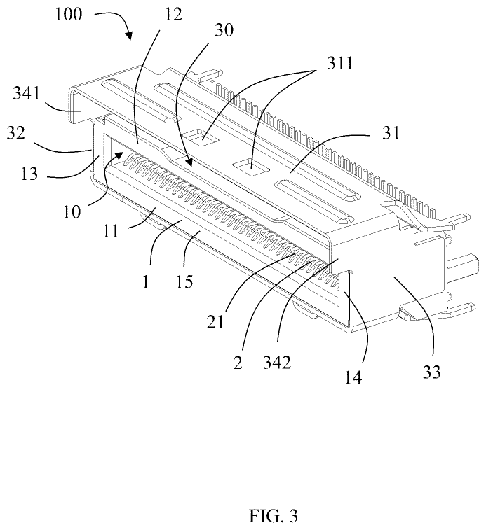

Referring to FIG. 2 and FIG. 3, the mating connector 100 includes a mating insulating body 1, a plurality of mating conductive terminals 2 and a metal shielding shell 3. The mating insulating body 1 includes an insertion surface 11 and an insertion slot 10 extending through the insertion surface 11. Specifically, the mating insulating body 1 includes a top wall portion 12, a first side wall portion 13, a second side wall portion 14 opposite to the first side wall portion 13, and a bottom wall portion 15 opposite to the top wall portion 12. The top wall portion 12, the first side wall portion 13, the second side wall portion 14 and the bottom wall portion 15 are enclosed to form the insertion slot 10.

Each mating conductive terminal 2 includes an elastic mating arm 21 extending into the insertion slot 10. In an embodiment of the present disclosure, the mating conductive terminals 2 are disposed in upper and lower rows, that is, the elastic mating arms 21 are disposed in the upper and lower rows and extend into the insertion slot 10.

The metal shielding shell 3 includes an upper wall 31 located at an upper end of the top wall portion 12, a first side end wall 32 bent downwardly from one side of the upper wall 31, and a second side end wall 33 bent downwardly from another side of the upper wall 31. The mating connector 100 includes a receiving cavity 30 located between the upper wall 31 and the top wall portion 12 in the top-bottom direction. The upper wall 31 includes two locking holes 311 spaced apart from each other along the left-right direction for locking with the electrical connector 200. The first side end wall 32 corresponds to the first side wall portion 13. The second side end wall 33 corresponds to the second side wall portion 14. The top wall portion 12 and the first side end wall 32 are jointly provided with a first L-shaped positioning protrusion 341 extending beyond the insertion surface 11. The top wall portion 12 and the second side end wall 33 are jointly provided with a second L-shaped positioning protrusion 342 extending beyond the insertion surface 11. The first L-shaped positioning protrusion 341 and the second L-shaped positioning protrusion 342 are located at an upper-left corner and an upper-right corner of the metal shielding shell 3, respectively. The first L-shaped positioning protrusion 341 and the second L-shaped positioning protrusion 342 are configured to be inserted into the electrical connector 200 to achieve positioning.

Referring to FIG. 2 and FIG. 4 to FIG. 8, the electrical connector 200 includes a first body 4, a conductive unit, a cable 6 fixed to the conductive unit, a second insulating body 7 matched with the first body 4 and an unlocking elastic piece 8 mounted to the first body 4. In the illustrated embodiment of the present disclosure, the first body 4 is a first insulating body, that is, it is made of an insulating material. In the embodiment shown in the present disclosure, the conductive unit is a built-in circuit board 5. Of course, in other embodiments, the conductive unit may also be conductive terminals or the like.

The first body 4 includes a main body portion 43, a first side wall 41 located on one side of the main body portion 43, a second side wall 42 located on another side of the main body portion 43, a top wall 44 extending in a first direction A1-A1 (for example, a front-rear direction) from a top of the main body portion 43, and a mating space 401 located at a front end of the main body portion 43. The mating space 401 is defined by at least the first side wall 41, the second side wall 42, the main body portion 43 and the top wall 44.

The top wall 44 of the first body 4 defines a mounting groove 4421 extending backwardly. The unlocking elastic piece 8 is mounted to the mounting groove 4421.

Besides, the top wall 44 of the first body 4 further defines a first positioning slot 441 that extends through the top wall 44 forwardly and a second positioning slot 442 that extends through the top wall 44 forwardly. The first positioning slot 441 and the second positioning slot 442 are disposed adjacent to the first side wall 41 and the second side wall 42, respectively. The first positioning slot 441 and the second positioning slot 442 are configured to cooperate with the first L-shaped positioning tab 341 and the second L-shaped positioning tab 342, respectively, in order to reduce the shaking when the mating connector 100 and the electrical connector 200 are mated with each other, thereby improving the mating stability between the electrical connector 200 and the mating connector 100.

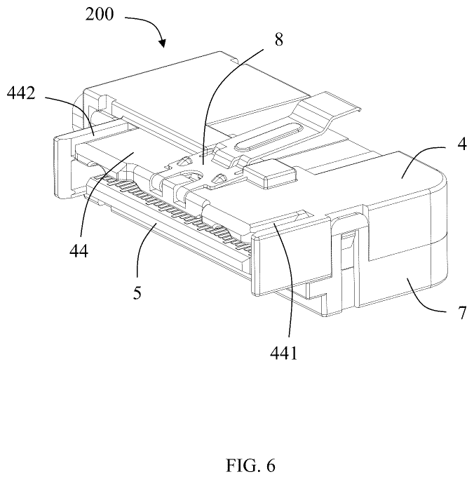

Referring to FIG. 6 to FIG. 12, in one embodiment of the present disclosure, the unlocking elastic piece 8 is made of a metal material and is generally U-shaped. The unlocking elastic piece 8 includes a fixing portion 81, a locking portion 82 spaced apart from the fixing portion 81, a connecting portion 83 connecting one end of the fixing portion 81 and one end of the locking portion 82, a connecting arm 84 connected to the locking portion 82, a support arm 85 connected to the locking portion 82, and a force-receiving portion 86 connected to the connecting arm 84 and the support arm 85. The support arm 85 is located beside of the connecting arm 84 along a second direction A2-A2 (for example, a left-right direction). The support arm 85 and the connecting arm 84 are disposed in a staggered manner along the first direction A1-A1. The second direction A2-A2 is perpendicular to the first direction-A1. In the illustrated embodiment of the present disclosure, the fixing portion 81, the connecting portion 83 and the locking portion 82 are U-shaped as a whole. The fixing portion 81 and the locking portion 82 are located on a same side of the connecting portion 83. The fixing portion 81 is fixed in the mounting groove 4421 of the first body 4. The locking portion 82 is provided with at least one locking element 821 (for example, a locking protrusion). The locking element 821 is configured to be lockable with the locking hole 311 of the mating connector 100. In the illustrated embodiment of the present disclosure, two locking elements 821 are provided, and they are spaced apart along the second direction A2-A2. In the illustrated embodiment of the present disclosure, the two locking elements 821 are integrally stamped from the locking portion 82, and the two locking elements 821 are aligned along the second direction A2-A2. The force-receiving portion 86 can directly or indirectly drive the locking portion 82 to move closer to the fixing portion 81 (i.e., elastically deform toward the space 80) under an action of an external force, thereby causing the locking element 821 to be disengaged from the locking hole 311 of the mating connector 100 to achieve unlocking. In the illustrated embodiment of the present disclosure, the connecting portion 83 is arc-shaped to better provide support for the deformation of the locking portion 82. The support arm 85 is configured to increase the rigidity of the locking portion 82 to reduce the risk of unlocking failure due to insufficient deformation of the locking portion 82. Of course, it is understandable to those skilled in the art that the positions of the locking protrusion and the locking hole 311 can also be exchanged. That is, the locking element 821 is a locking hole 311 and is provided on the locking portion 82. The locking protrusion mating with the locking hole 311 is provided on the mating connector 100.

In the illustrated embodiment of the present disclosure, the locking portion 82 and the fixing portion 81 are spaced apart along a third direction A3-A3 (for example, a top-bottom direction). The locking portion 82 is located above the fixing portion 81. The unlocking elastic piece 8 includes a space 80 located between the locking portion 82 and the fixing portion 81. The third direction A3-A3 is perpendicular to the first direction A1-A1 and the second direction A2-A2.

In the illustrated embodiment of the present disclosure, the connecting arm 84 and the support arm 85 are both connected between the locking portion 82 and the force-receiving portion 86. The support arm 85 includes a first support arm 851 and a second support arm 852. The first support arm 851 and the second support arm 852 are located on two sides of the connecting arm 84 along the second direction A2-A2.

In the illustrated embodiment of the present disclosure, the first support arm 851, the second support arm 852 and the connecting arm 84 are all inclined. The first support arm 851 and the second support arm 852 are disposed further away from the connecting portion 83 than the connecting arm 84. In other words, in the illustrated embodiment of the present disclosure, the first support arm 851 and the second support arm 852 are located at rear ends of the connecting arm 84 along the first direction A1-A1.

Specifically, the first support arm 851 includes a first end 8511 connected to the locking portion 82 and a second end 8512 connected to the force-receiving portion 86. The second support arm 852 includes a third end 8521 connected to the locking portion 82 and a fourth end 8522 connected to the force-receiving portion 86. The connecting arm 84 includes a fifth end 841 connected to the locking portion 82 and a sixth end 842 connected to the force-receiving portion 86. The first end 8511 and the third end 8521 are both located at rear ends of the fifth end 841 along the first direction A1-A1. The second end 8512 and the fourth end 8522 are both located at rear ends of the sixth end 842 along the first direction A1-A1.

In the illustrated embodiment of the present disclosure, the first end 8511, the third end 8521 and the fifth end 841 are located in a same first plane. The second end 8512, the fourth end 8522, and the sixth end 842 are located in a same second plane. The second plane is higher than the first plane.

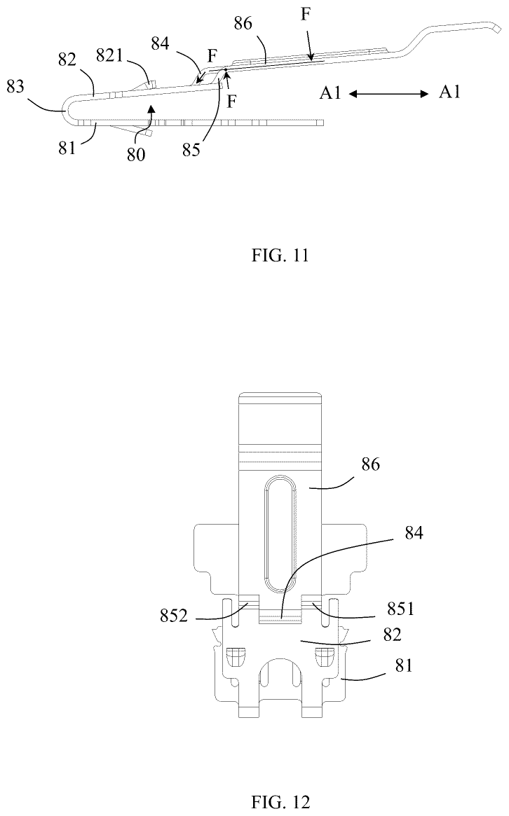

In the illustrated embodiment of the present disclosure, a width of the connecting arm 84 along the second direction A2-A2 is greater than a width of the first support arm 851 along the second direction A2-A2. The width of the connecting arm 84 along the second direction A2-A2 is also greater than a width of the second support arm 852 along the second direction A2-A2. With this arrangement, when an external force acts on the force-receiving portion 86, the force-receiving portion 86 can transmit the force to the locking portion 82 through the relatively wide connecting arm 84, thereby driving the locking portion 82 to elastically deform into the space 80 and move towards the fixing portion 81. At the same time, when the external force acts on the force-receiving portion 86, the force-receiving portion 86 can also transmit the force to the locking portion 82 through the relatively narrow first support arm 851 and the second support arm 852, thereby also driving the locking portion 82 to elastically deform into the space 80 and move towards the fixing portion 81. In the present disclosure, by arranging the first support arm 851 and the second support arm 852 at the rear ends of the connecting arm 84, the first support arm 851 and the second support arm 852 can be disposed closer to the force-receiving portion 86. When the force-receiving portion 86 receives the external force, the first support arm 851 and the second support arm 852 can form a balance lever (referring to FIG. 11), thereby improving a defect that a connection between the connecting arm 84 and the force-receiving portion 86 is prone to elastic deformation. Finally, the external force exerted on the force-receiving portion 86 can be better transmitted to the locking portion 82 and drive the locking portion 82 to undergo elastic deformation. As a result, it reduces the risk of unlocking failure due to insufficient elastic deformation of the locking portion 82.

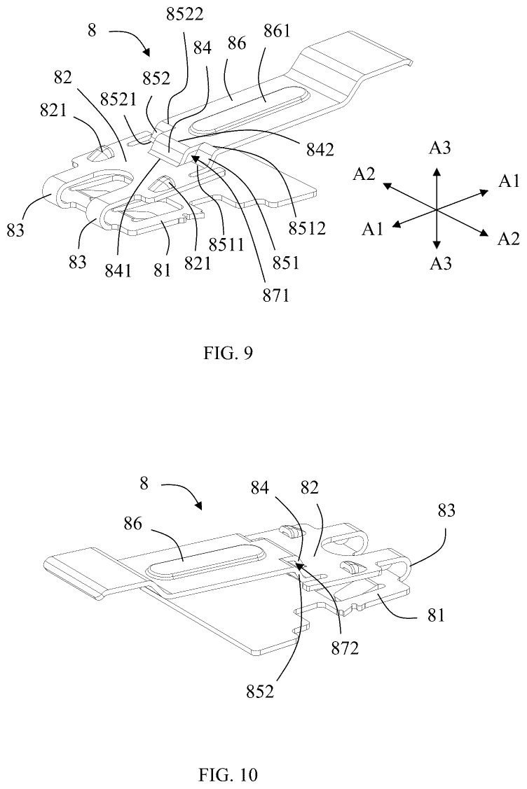

Referring to FIG. 9 to FIG. 12, in a first embodiment of the unlocking elastic piece 8 of the present disclosure, the unlocking elastic piece 8 includes a first tearing opening 871 located between the connecting arm 84 and the first support arm 851 along the second direction A2-A2, and a second tearing opening 872 located between the connecting arm 84 and the second support arm 852 along the second direction A2-A2. The first support arm 851 and the second support arm 852 are integrally stamped from the unlocking elastic piece 8. Specifically, the first support arm 851 and the second support arm 852 are formed by tearing the unlocking elastic piece 8.

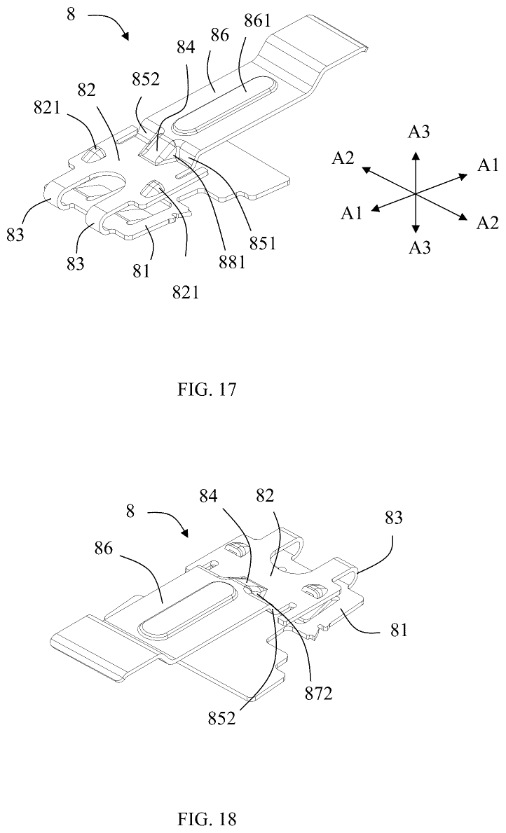

As shown in FIG. 17 to FIG. 20, in a second embodiment of the unlocking elastic piece 8 of the present disclosure, the first support arm 851 and the second support arm 852 are seamlessly connected to the connecting arm 84. The unlocking elastic piece 8 includes a first reinforced side wall 881 located between the connecting arm 84 and the first support arm 851 along the second direction A2-A2, and a second reinforced side wall 882 located between the connecting arm 84 and the second support arm 852 along the second direction A2-A2. The first support arm 851 and the second support arm 852 are integrally stamped from the unlocking elastic piece 8. Specifically, the first support arm 851 and the second support arm 852 are formed from the unlocking elastic piece 8 without being torn.

Besides, in the illustrated embodiment of the present disclosure, the force-receiving portion 86 includes a reinforcing rib 861 extending along the first direction A1-A1 to increase the structural strength of the force-receiving portion 86.

When unlocking is required, an external force may directly act on the force-receiving portion 86 or transmit the external force to the force-receiving portion 86 by pulling a strap (not shown) connected to the force-receiving portion 86. The force-receiving portion 86 transmits the external force to the locking portion 82 through the first support arm 851, the second support arm 852 and the connecting arm 84, and drives the locking portion 82 to move closer to the fixing portion 81 (for example, elastically deform downwardly), so that the locking element 821 is separated from the locking hole 311 of the mating connector 100 to achieve unlocking. The first support arm 851 and the second support arm 852 can form a balance lever (referring to FIG. 11), thereby improving the defect that the connection between the connecting arm 84 and the force-receiving portion 86 is prone to elastic deformation. Finally, the external force exerted on the force-receiving portion 86 can be better transmitted to the locking portion 82 and drive the locking portion 82 to undergo elastic deformation. This reduces the risk of unlocking failure due to insufficient elastic deformation of the locking portion 82.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An unlocking elastic piece, comprising:
a fixing portion, the fixing portion being configured to be mounted to a first body of an electrical connector;
a locking portion, the locking portion being provided with at least one locking element which is lockable with a mating connector;
a connecting portion, the connecting portion connecting one end of the fixing portion and one end of the locking portion;
a connecting arm, the connecting arm being connected to the locking portion;
a support arm, the support arm being connected to the locking portion, the support arm being located beside the connecting arm, the support arm and the connecting arm being disposed in a staggered manner along a first direction; and
a force-receiving portion, both the connecting arm and the support arm being connected between the locking portion and the force-receiving portion, the force-receiving portion being configured to drive the locking portion to elastically deform under an action of an external force, thereby causing the locking element to separate from the mating connector.

2. The unlocking elastic piece according to claim 1, wherein the support arm comprises a first support arm and a second support arm; the first support arm and the second support arm are located on two sides of the connecting arm along a second direction which is perpendicular to the first direction.

3. The unlocking elastic piece according to claim 2, wherein the first support arm, the second support arm and the connecting arm are all disposed in an inclined manner; both the first support arm and the second support arm are disposed further away from the connecting portion than the connecting arm.

4. The unlocking elastic piece according to claim 2, further comprising a first tearing opening located between the connecting arm and the first support arm along the second direction, and a second tearing opening located between the connecting arm and the second support arm along the second direction.

5. The unlocking elastic piece according to claim 2, wherein the first support arm and the second support arm are seamlessly connected to the connecting arm; the unlocking elastic piece comprises a first reinforced side wall located between the connecting arm and the first support arm along the second direction, and a second reinforced side wall located between the connecting arm and the second support arm along the second direction.

6. The unlocking elastic piece according to claim 2, wherein a width of the connecting arm along the second direction is greater than a width of the first support arm along the second direction; and the width of the connecting arm along the second direction is also greater than a width of the second support arm along the second direction.

7. The unlocking elastic piece according to claim 2, wherein the first support arm comprises a first end connected to the locking portion and a second end connected to the force-receiving portion;
the second support arm comprises a third end connected to the locking portion and a fourth end connected to the force-receiving portion;
the connecting arm comprises a fifth end connected to the locking portion and a sixth end connected to the force-receiving portion;
wherein the first end and the third end are both located at rear ends of the fifth end along the first direction; the second end and the fourth end are both located at rear ends of the sixth end along the first direction.

8. The unlocking elastic piece according to claim 7, wherein the first end, the third end and the fifth end are located in a same first plane; the second end, the fourth end and the sixth end are located in a same second plane which is higher than the first plane.

9. The unlocking elastic piece according to claim 1, wherein the locking portion is spaced apart from the fixing portion; a space is formed between the locking portion and the fixing portion; the fixing portion and the locking portion are located on a same side of the connecting portion; the force-receiving portion is configured to drive the locking portion to deform into the space under the action of the external force, thereby causing the locking element to separate from the mating connector.

10. The unlocking elastic piece according to claim 1, wherein the locking element is a locking protrusion.

11. The unlocking elastic piece according to claim 1, wherein the force-receiving portion comprises a reinforcing rib extending along the first direction.

12. An electrical connector, comprising:
a first body, the first body defining a mounting groove; and
an unlocking elastic piece, comprising:
a fixing portion, the fixing portion being fixed in the mounting groove;
a locking portion, the locking portion being provided with at least one locking element which is lockable with a mating connector;
a connecting portion, the connecting portion connecting one end of the fixing portion and one end of the locking portion;
a connecting arm, the connecting arm being connected to the locking portion;
a support arm, the support arm being connected to the locking portion, the support arm being located beside the connecting arm, the support arm and the connecting arm being disposed in a staggered manner along a first direction; and
a force-receiving portion, both the connecting arm and the support arm being connected between the locking portion and the force-receiving portion, the force-receiving portion being configured to drive the locking portion to elastically deform under an action of an external force, thereby causing the locking element to separate from the mating connector.

13. The electrical connector according to claim 12, wherein the support arm comprises a first support arm and a second support arm; the first support arm and the second support arm are located on two sides of the connecting arm along a second direction which is perpendicular to the first direction.

14. The electrical connector according to claim 13, wherein the first support arm, the second support arm and the connecting arm are all disposed in an inclined manner; both the first support arm and the second support arm are disposed further away from the connecting portion than the connecting arm.

15. The electrical connector according to claim 13, further comprising a first tearing opening located between the connecting arm and the first support arm along the second direction, and a second tearing opening located between the connecting arm and the second support arm along the second direction.

16. The electrical connector according to claim 13, wherein the first support arm and the second support arm are seamlessly connected to the connecting arm; the unlocking elastic piece comprises a first reinforced side wall located between the connecting arm and the first support arm along the second direction, and a second reinforced side wall located between the connecting arm and the second support arm along the second direction.

17. The electrical connector according to claim 13, wherein a width of the connecting arm along the second direction is greater than a width of the first support arm along the second direction; and the width of the connecting arm along the second direction is also greater than a width of the second support arm along the second direction.

18. The electrical connector according to claim 13, wherein the first support arm comprises a first end connected to the locking portion and a second end connected to the force-receiving portion;
the second support arm comprises a third end connected to the locking portion and a fourth end connected to the force-receiving portion;
the connecting arm comprises a fifth end connected to the locking portion and a sixth end connected to the force-receiving portion;
wherein the first end and the third end are both located at rear ends of the fifth end along the first direction; the second end and the fourth end are both located at rear ends of the sixth end along the first direction.

19. The electrical connector according to claim 18, wherein the first end, the third end and the fifth end are located in a same first plane; the second end, the fourth end and the sixth end are located in a same second plane which is higher than the first plane.

20. The electrical connector according to claim 12, wherein the locking portion is spaced apart from the fixing portion; a space is formed between the locking portion and the fixing portion; the fixing portion and the locking portion are located on a same side of the connecting portion; the force-receiving portion is configured to drive the locking portion to deform into the space under the action of the external force, thereby causing the locking element to separate from the mating connector.
